(19) United States
(12) Patent Application Publication
(10) Pub. No.: US 2018/0015000 A1
(43) Pub. Date: Jan. 18, 2018

(54) AUTONOMOUS FEEDING SYSTEM

(71) Applicant: Starr Olson, West Saint Paul, MN (US)

(72) Inventor: Starr Olson, West Saint Paul, MN (US)

(21) Appl. No.: 15/208,325

(22) Filed: Jul. 12, 2016

(51) Int. Cl. A61J 7/00; B65D 41/00

(52) U.S. Cl. CPC A61J 7/0053; B65D 41/00

(57) ABSTRACT

An apparatus and method for an autonomous feeding system allows a user to draw liquid or semi-solid nutrition from a receptacle by creating a negative pressure environment through sucking. The autonomous feeding system includes an adapter that is adapted to receive a conduit and conformingly fit about and substantially form a seal around the rim of a receptacle, such as a baby food jar.

### FIELD OF THE INVENTION

This present invention relates generally to apparatus and methods for inducing the flow of liquid or semi-solid material from a receptacle to an exit port via a removable, flexible conduit, and, more particularly, to an adapter for a baby food jar that facilitates the ability of a young child to feed himself or herself without the use of a utensil.

### BACKGROUND

For many children, the transition from a purely liquid diet to semi-solid food begins between the ages of four months and eight months. During this period, consumption of milk and/or formula gradually decreases while the child is introduced to different types of food.

To facilitate the consumption and digestion of these foods, as well as to avoid choking, foods like vegetables, fruit and meats are generally puréed prior to being fed to the child. As a baby continues to develop and grow, an increasing proportion of the child's diet is derived from semi-solid foods. Although feeding practices vary widely in response to the particular needs of children and based on different cultural practices, puréed and semi-solid foods are an important, if not the primary, source of nutrition for children by twelve months of age.

Numerous options are available to assist in transitioning young children from a diet based on milk or formula to solid food. For example, ready-to-eat puréed food can be purchased in small jars and other receptacles. Parents and other caregivers typically feed children this food through the use of a spoon or other suitable utensil.

A common drawback of this process is the substantial amount of time required to feed a young child—often several times per day—using a spoon. Also, children transitioning away from a purely liquid diet frequently expectorate the new form of food. This can be the result of a young child's inability to control his or her tongue or resistance to consumption of the new food type. Additionally, children often have a growing desire to be independent and feed themselves as they mature. During the age when puréed food comprises a significant portion of a child's diet, however, children may lack the fine motor skills necessary to efficiently use a utensil such as a spoon, resulting in significant spillage of unconsumed food. For all of the foregoing reasons, the process of feeding puréed food with a spoon to young children produces waste, creates an untidy environment and consumes significant amount of the caregiver's time.

Although the process of transitioning a child from a liquid diet to solid food can be a desirable experience for many parents, for others it can be a tremendous burden and an enduring source of tension. Furthermore, the multitude of challenges associated with feeding puréed food to children can be exacerbated in settings with multiple children, such as in daycare facilities and households with children from multi-offspring births (i.e., twins, triplets, etc.). As a result, there is a need for improving the process of feeding puréed and semi-solid food to children. In particular, there is a need for improved apparatus and methods that reduce waste and feeding time while providing a young child with the means to autonomously feed himself or herself.

### SUMMARY

An autonomous feeding system allows a baby to feed himself or herself from a receptacle such as a jar without the use of a spoon or other utensil. This reduces wastes and increases cleanliness significantly reducing the assistance and supervision required from a parent or other caregiver. The autonomous feeding system can replace jar tops or other container covers that are commonly used by baby food manufacturers to seal the receptacle containing the food.

In an embodiment, an autonomous feeding system includes an adapter that can be fitted over a receptacle containing food and a conduit that can be attached to the adapter. The adapter includes a cover portion that is positioned over the opening of receptacle and outer and inner sidewalls that defines a gap which forms a seal around the lip of the receptacle. The adapter includes a tubular extension upon which a young child can suck to create a negative pressure that draws liquid or semi-solid food through the tubular extension and into the child's mouth. The adapter may also include a projection that receives and forms a seal about the conduit, thus positioning the conduit to extend into the receptacle.

In some embodiments, the outside surface of the outer sidewalls may include ridges to facilitate gripping and removal of the autonomous feeding system. The adapter is generally made of a flexible material, while the conduit is generally from a relatively stiffer material. This construction allows the autonomous feeding system to effectively reach the bottom of receptacle, particularly when portions of the autonomous feeding system must flex in response to the concave bottom surface of certain glass baby food jars. The conduit is generally open at the bottom end and may be canted to conform to the corner of the receptacle.

The opening in the distal end of the tubular extension is configured to permit the flow of puréed or other semi-solid food therethrough under negative pressure, while preventing the flow of puréed or other semi-solid food when the receptacle is inverted. In one embodiment, the opening forms a cross-shaped exit port that only permits the flow of puréed or other semi-solid food when a child sucks on the tubular extension or squeezes the receptacle.

In an embodiment, the cover portion, the outer and inner sidewalls, the projection and the tubular extension are integrally formed. In a further embodiment, the conduit is also integrally formed from the same material such that the autonomous feeding system is an integral unit. In other embodiments, an adapter for older children may have relatively larger openings to permit small portions of solid food to be drawn through the channels in the autonomous feeding system.

Certain advantages of the apparatus and methods of the present invention include reduced feeding time for food from a baby food jar, and reduction or elimination of spillage of food from the baby food jar. The autonomous feeding system also increases mobility and portability of baby food jars by eliminating the need for a spoon, while allowing the baby food jar or other receptacle to be held by the baby while on the go

The adapter of the autonomous feeding system is generally configured to be fitted to a standard-size baby food jar or other receptacle. It may include several sizes of adapter, or a universal adapter that fit various makes of receptacle. The conduit made include various lengths to fit various sizes of jars. Alternatively, the conduits made include indicia to guide a user in cutting a conduit to a proper size. In various embodiments, the autonomous cleaning device may include a cleaning brush and/or receptacles adapted to store various types of food.

Unless otherwise defined, all technical and scientific terms used herein have the same meaning as commonly understood by one of ordinary skill in the art. Although methods and materials similar or equivalent to those described herein can be used in the practice or testing of any described embodiment, suitable methods and materials are described below. In addition, the materials, methods, and examples are illustrative only and not intended to be limiting. In case of conflict with terms used in the art, the present specification, including definitions, will control.

The foregoing summary is illustrative only and is not intended to be in any way limiting. In addition to the illustrative aspects, embodiments, and features described above, further aspects, embodiments, and features will become apparent by reference to the drawings and the following detailed description and claims.

### BRIEF DESCRIPTION OF THE DRAWINGS

The present embodiments are illustrated by way of the figures of the accompanying drawings, which may not necessarily be to scale, in which like references indicate similar elements, and in which:

FIG. 1 is a front elevational view of an autonomous feeding system;

FIG. 2 of a cross-sectional view of the autonomous feeding system of FIG. 1;

FIG. 3A is front elevational view of an adapter for the autonomous feeding system of FIG. 1;

FIG. 3B is front elevational view of an adapter for the autonomous feeding system of FIG. 1;

FIG. 4A of a cross-sectional view of the adapter of FIG. 3A;

FIG. 4B of a cross-sectional view of the adapter of FIG. 3A;

FIG. 5 is a top plan view of the adapter of FIG. 3A;

FIG. 6 is a bottom plan view of the adapter of FIG. 3A;

FIG. 7 is a perspective view of an adapter of an autonomous feeding system;

FIG. 8 is a top plan view of a portion of an adapter of an autonomous feeding system;

FIG. 9 is a perspective view of a conduit of an autonomous feeding system;

FIG. 10 is a side elevation view of an autonomous feeding system coupled to a receptacle; and

FIG. 11 is an illustration of an autonomous feeding system in use.

### DESCRIPTION OF THE PREFERRED EMBODIMENTS

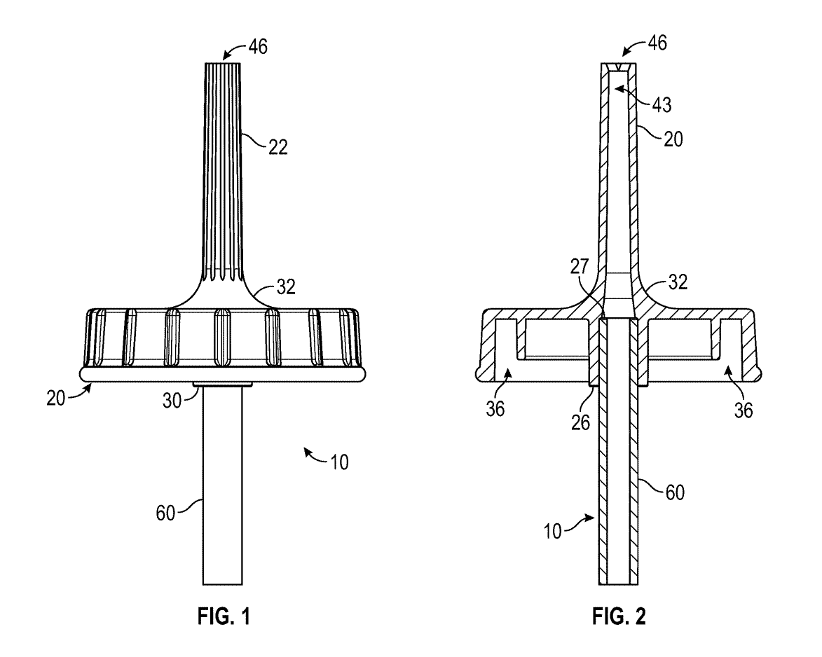

An autonomous feeding system 10 according to an embodiment is depicted generally in FIG. 1. Although autonomous feeding system 10 can be used for any number of purposes, the illustrated embodiment is especially adapted for delivering liquid or semi-liquid (alternately referred to as semi-solid) nutrition to a user. Autonomous feeding system 10 may be particularly useful in facilitating autonomous feeding (i.e., feeding oneself) by a young child from a receptacle containing puréed baby food.

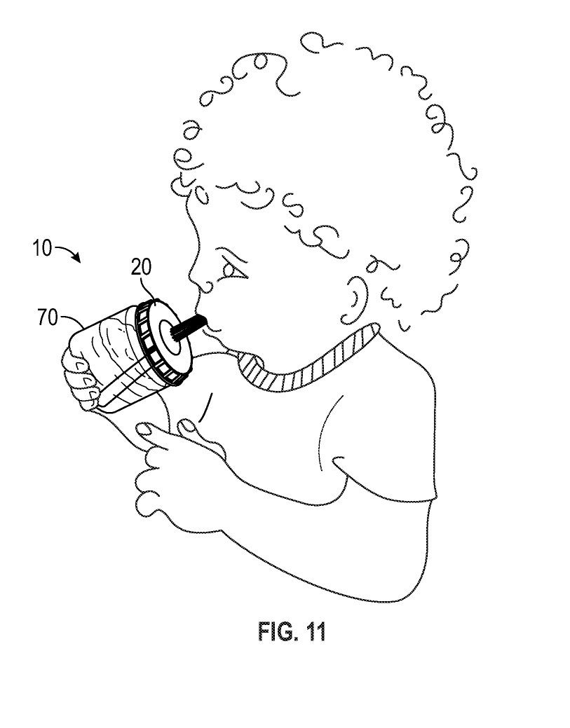

Referring to FIGS. 1-2, autonomous feeding system 10 generally includes adapter 20 and conduit 60. In embodiments, autonomous feeding system 10 may also include a receptacle 70, such as the jar depicted in FIGS. 10-11. It will be easily recognized that the receptacle 70 can be a common baby food jar, or other well-known container that typically contains liquid or semi-liquid food.

As shown in FIGS. 1-4, adapter 20 generally includes extension 22, cover portion 24, outer sidewalls 26, inner sidewalls 28 and projection 30. Adapter 20 may also include transition area 32 between extension 22 and cover portion 24, as well as lip 34. Outer sidewalls 26 may include ridges 35 adapted to facilitate gripping of outer sidewalls 26 by a user. As outlined below in further detail, adapter 20 is specifically configured to be coupled with the receptacle 70, thus providing the ability for a young child to feed themselves.

Outer sidewalls 26 extend circumferentially about cover portion 24. Inner sidewalls 28 are spaced apart from outer sidewalls 26 such that inner sidewalls 28 and outer sidewalls 26 form gap 36. Outer sidewalls 26 and inner sidewalls 28 extend generally away from extension 22. Gap 36 is generally configured to conformingly receive receptacle 70 so as to form a substantially liquid-impermeable compression fit, or seal, about a rim portion of the receptacle.

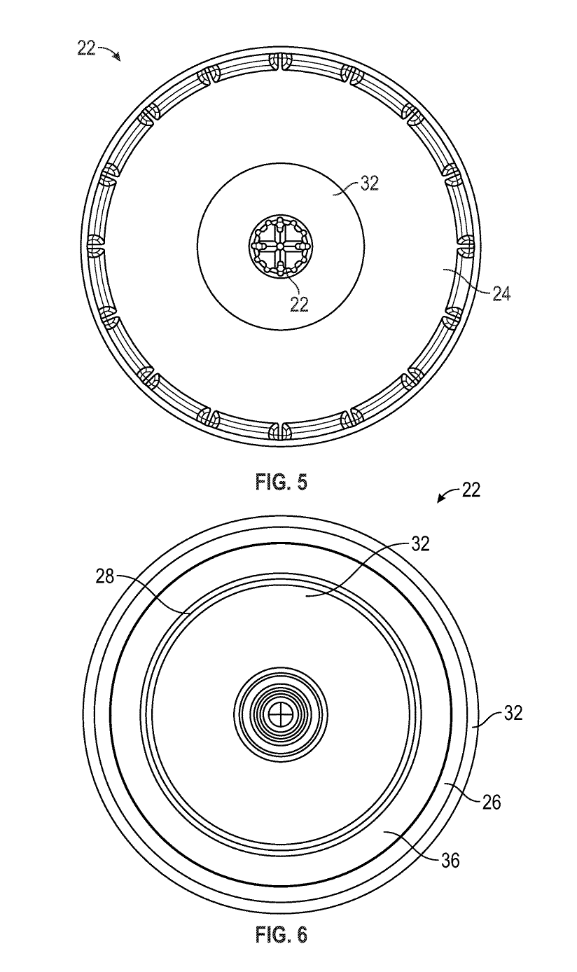

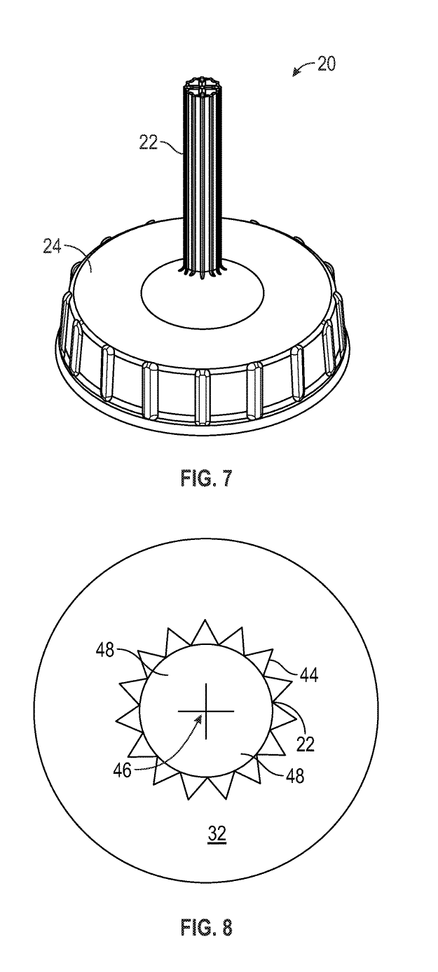

As shown in FIGS. 1-7, cover portion 24, outer sidewalls 26 and inner sidewalls 28 are adapted to a receive a receptacle having a substantially circular opening, such as the receptacles shown and described in USD289259, USD298592, USD516429 and USD754544. In alternative embodiments, cover portion 24, outer sidewalls 26 and inner sidewalls 28 are configured to receive a receptacle defining a non-circular opening, such as a baby food container defining a substantially rectangular opening.

Extension 22 includes elongated portion 38 having a proximal end 40 and distal end 42. Extension 22 defines extension channel 43 and may also include ribbing 44 extending between proximal end 40 and distal end 42. As depicted in FIGS. 1-4, proximal end 40 terminates in transition area 32. Alternatively, proximal end 40 may terminate in cover portion 24 without the presence of transition area 32. Distal end 42 of extension 22 defines opening 46. Opening 46 may be configured in any number of ways. As depicted in FIG. 8, for example, distal end 42 of extension includes a plurality of flaps 48 arranged so as to define opening 46 in a cross, or “+,” shape. In an alternative embodiment, distal end 42 may define a single slit such that deformation of distal end 42 produces opening 46. In yet another embodiment, distal end 42 defines an unobstructed aperture. A feature and advantage of the present system is the ability to modify the size and/or shape of opening 46 so as to control the flow rate of non-solid materials, such as puréed baby food, through extension channel 43.

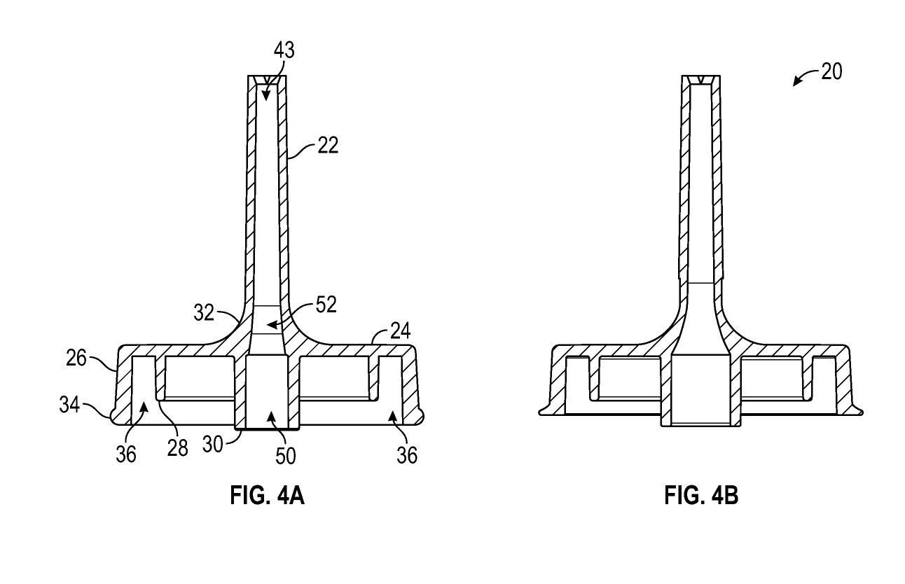

Projection 30 generally extends away from extension 22 in a direction that is substantially parallel with outer sidewalls 26 and inner sidewalls 28. As shown in FIGS. 1-4, projection 30 extends slightly beyond the plane defined by lip 34. In alternative embodiments, projection 30 may extend before or substantially coextensive with the plane defined by lip 34. Projection 30 also defines projection channel 50 adapted to receive conduit 60. Projection channel 50 is in fluid communication with channel 43 of elongated portion 38 of extension 22. As shown in FIGS. 2 and 4, extending between and in fluid communication with projection channel 50 and extension channel 43 is transition area channel 52. Transition area channel 52 may be chamfered to facilitate the formation of a compression fit about conduit 60. The location in transition area channel 52 or projection channel 50 at which conduit 60 occupies a resting position is referred to herein as the conduit stop. Referring to FIG. 2, conduit stop 27 is shown as the location where projection 26 meets transition area 32.

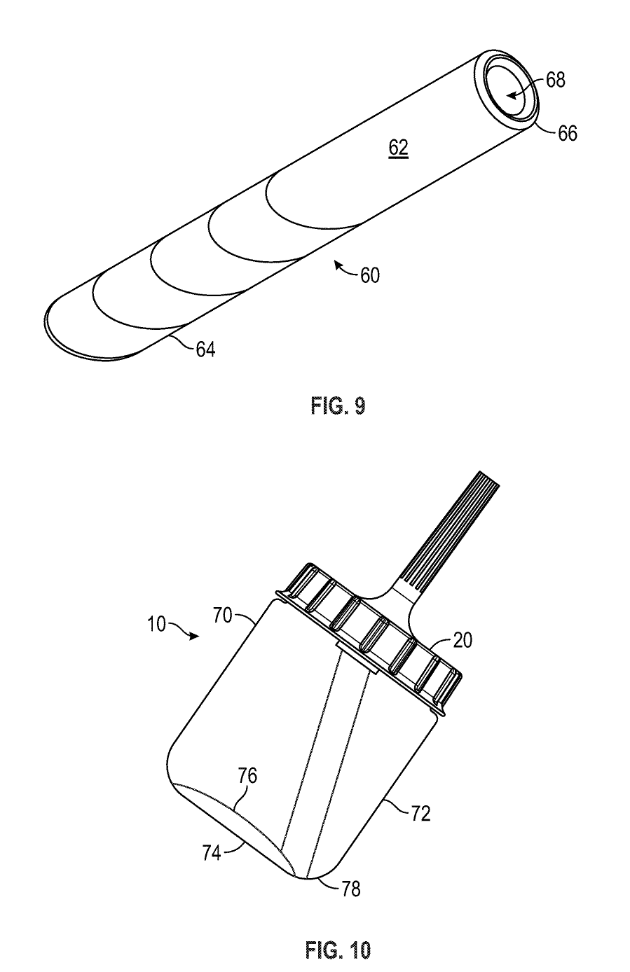

Conduit 60 is a generally tubular member 62 having first end 64 and a second end 66. Conduit 60 defines conduit channel 68 extending between the first and second ends 64, 66. Although FIGS. 1 and 9-11 depict conduit 60 as a generally linear structure, conduit 60 may be non-linear as well. First end 64 of conduit 60 is adapted to be received by projection channel 50 such that projection 50 forms a seal around first end 64 of conduit. Therefore, the diameter of conduit 60 will generally be minimally larger that the diameter of projection channel 50. Second end 66 of conduit 60 may have the same of different dimensions as first end 64 of conduit. In an embodiment, second end 64 is canted with respect to tubular member. Although the diameters of conduit channel 68 and extension channel 43 can be different, they are generally substantially similar or the same to facilitate cleaning of the conduit channel 68 and extension channel 43 with a single cleaning device, such as a tube brush.

The length of conduit 60 can be varied in accordance with user preference. Additionally, various conduits 60 of different length may be provided such that a user can select the optimum length for a given receptacle 70. Referring to FIG. 4, a type of receptacle 70, such as glass baby food jar, has sidewalls 72 and bottom surface 74. Bottom surface 74 is concave such that bottom surface 74 has apex 76 and defines circumferential furrow 78 where sidewalls 72 meet bottom surface 74. In an embodiment, tubular member 62 has a length that is substantially equal to the distance between furrow 78 and stop 27.

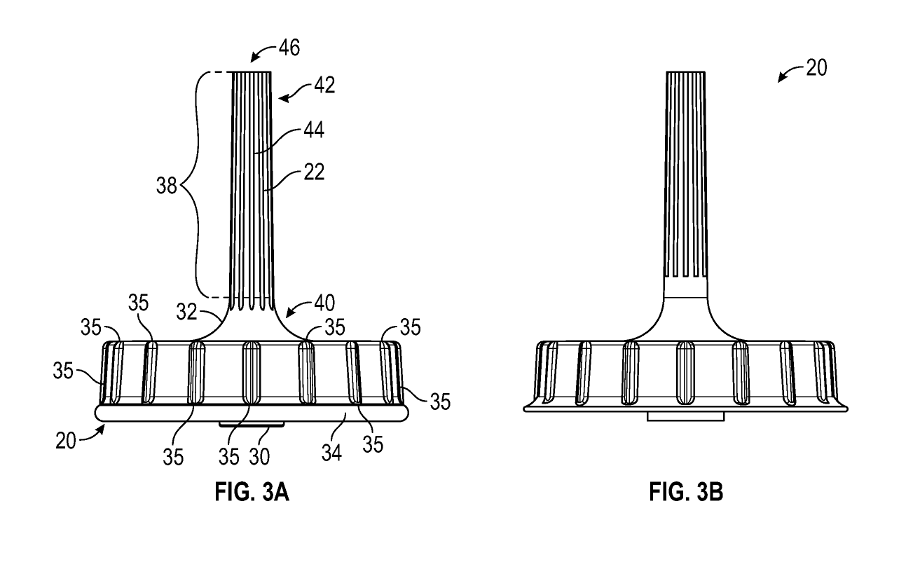

The dimensions of the various features and components of autonomous feeding system 10 can be varied to conform to them to the sizes and shapes of different types of receptacles 70. In the embodiment depicted in FIGS. 3b and 4b, autonomous feeding system 10 is adapted to 4 oz. or 6 oz. baby food jars manufactured by Gerber®, Beech-Nut® and/or Earth's Best Organic®.

Adapter 20 is preferably made from a resilient polymer, although other materials could be used. In an embodiment, the heretofore described components of adapter 20 are integrally formed from a silicone polymer. In an alternative embodiment, outer sidewalls 26 of adapter 20 are made from a rigid material, such as plastic or metal, and may include complementary threads such that adapter 20 can be screwed onto the threaded rim portion of receptacle 70. Conduit 60 is generally made from a polymer characterized by a greater degree of stiffness. In an embodiment, conduit 60 is made from BPA-free plastic. One skilled in the art will readily recognize, however, that adapter 20 and conduit 60 can be made from any number of materials without departing from the spirit or scope of the present invention.

Autonomous feeding system 10 can be used for any number of purposes; however, autonomous feeding system 10 is particularly adapted to provide facilitate utensil-free extraction of semi-solid or puréed food from a jar. In this manner, a young child can feed himself or herself by simply sucking on a straw-like flexible tube rather than requiring the assistance of a parent or other caregiver in being fed by a spoon.

A method according to an embodiment of the present invention includes inserting conduit 60 into projection 30 and subsequently fitting cover portion 24 of adapter 20 about the rim of receptacle 70. Since adapter 20 is generally made from a substantially resilient material, cover portion 24 can be stretch-fit about and forms a seal around the rim of receptacle 70. As previously described, outer sidewalls 26 may alternatively be made from a rigid material and include interior-facing threads such that adapter 20 can be screwed onto receptacle 70. Embodiments in which outer sidewalls 26 are threaded typically will not include inner sidewalls 28.

As adapter 20 is fitted about receptacle 70, the concave shape of bottom surface 74 of receptacle 70 naturally urges second end 66 of conduit 60 toward furrow 78, as shown in FIG. 10. In embodiments, the inherent elasticity of cover portion 24 provides assistance in retaining of second end 66 of conduit 60 within furrow 78. With conduit 60 positioned in furrow 78, receptacle 70 can be oriented by a user so as to maximize the quantity of food that can be accessed by a user with autonomous feeding system 10.

Since adapter 20 is substantially sealed about receptacle 70 and conduit 60 is substantially sealed within projection 30 while channel 43 of extension 22 remains in fluid communication with conduit channel 68, a user can create negative pressure by sucking on distal end 42 of extension 22. This negative pressure causes a liquid or puréed (or other semi-solid) food to be drawn from receptacle 70, through conduit channel 68 and extension channel 43, and exit through opening 46 in distal end 42 of extension 22. When the user is done sucking on extension 22 and the pressure is equalized, the small size of opening 46 substantially prevents the liquid or puréed food from leaking through opening 46 even if receptacle 70 is tipped sideways or upside-down.

Various embodiments of the invention have been described above for purposes of illustrating the details thereof and to enable one of ordinary skill in the art to make and use the invention. The details and features of the disclosed embodiment or embodiments are not intended to be limiting, as many variations and modifications will be readily apparent to those of skill in the art. Accordingly, the scope of the present disclosure is intended to be interpreted broadly and to include all variations and modifications coming within the scope and spirit of the appended claims and their legal equivalents.

1. An autonomous feeding system for extracting a semi-solid food from a receptacle having a rim defining a receptacle opening, comprising:
a cover portion positionable over the receptacle opening, the cover portion having an undersurface and a top surface;
an outer sidewall defining a first perimeter on the undersurface;
an inner sidewall defining a second perimeter on the undersurface, the inner sidewall spaced apart from the outer sidewall to form a gap adapted to receive the rim of the receptacle;
a tubular extension extending away from the top surface of the cover portion, the tubular extension defining an extension channel and having a distal end defining an opening and a proximal end adjacent the cover portion; and
a conduit defining a conduit channel and positionable to extend away from the undersurface of the cover portion while in fluid communication with the extension channel of the tubular extension.

2. The autonomous feeding system of claim 1, wherein the cover portion, the outer sidewall, the inner sidewall and the tubular extension are integrally formed into an adapter.

3. The autonomous feeding system of claim 2, wherein the inner sidewall, the outer sidewall and the rim of the receptacle are adapted to form a rim seal within the gap.

4. The autonomous feeding system of claim 3, wherein the rim seal substantially prevents semi-solid food from entering the gap.

5. The autonomous feeding system of claim 4, wherein the rim seal substantially prevents liquid food from entering the gap.

6. The autonomous feeding system of claim 5, wherein the rim seal substantially prevents air from entering the gap.

7. The autonomous feeding system of claim 3, wherein the adapter includes an opening adapted to receive a first end of the conduit, the opening and the first end of the conduit forming a conduit seal at a conduit-extension interface.

8. The autonomous feeding system of claim 7, wherein the adapter further includes a projection extending away from the undersurface at the opening, the projection defining a projection channel in fluid communication with the extension channel.

9. The autonomous feeding system of claim 8, wherein the conduit seal substantially prevents the semi-solid food from entering the conduit-extension interface.

10. The autonomous feeding system of claim 9, wherein the conduit seal substantially prevents a liquid from entering the conduit-extension interface.

11. The autonomous feeding system of claim 10, wherein the conduit seal substantially prevents air from entering the conduit-extension interface.

12. The autonomous feeding system of claim 7, wherein:
the receptacle includes a concave bottom surface, a cylindrical sidewall and a furrow between the concave bottom surface and the cylindrical sidewall, the furrow defining a perimeter of the receptacle;
the conduit adapted to extend between the furrow and the opening of the adapter; and
the adapter is made from a flexible material such that the conduit is flexibly positioning within the receptacle.

13. The autonomous feeding system of claim 7, wherein the distal end of the tubular extension includes an exit port adapted to impede the semi-solid food from flowing through the exit port when the receptacle opening is positioned downward while permitting the semi-solid food to flower through the exit port when subject to a negative pressure differential.

14. The autonomous feeding system of claim 13, wherein the exit port is cross-shaped.

15. The autonomous feeding system of claim 14, wherein the semi-solid food is puréed baby food.

16. A method of facilitating autonomous feeding by a child of a semi-solid food contained in a receptacle, the receptacle having a rim and defining a receptacle opening, the method comprising:
providing an adapter comprising:
a cover portion, the cover portion having an undersurface and a top surface;
an outer sidewall defining a first perimeter on the undersurface;
an inner sidewall defining a second perimeter on the undersurface, the inner sidewall spaced apart from the outer sidewall to form a gap;
a tubular extension extending away from the top surface of the cover portion, the tubular extension defining an extension channel and having a distal end defining an opening and a proximal end adjacent the cover portion; and
a projection extending away from the undersurface at the opening, the projection defining a projection channel in fluid communication with the extension channel; and
providing a conduit defining a conduit channel;
positioning the conduit adjacent the undersurface of the cover portion to extend away from the undersurface of the cover portion;
maintaining fluid communication between the extension channel and the tubular extension;
positioning the cover portion over the receptacle opening; and
inserting the rim of the receptacle into the gap.

17. The method of claim 16, further comprising:
sealing the rim of the receptacle with the gap; and
sealing the conduit within the projection;
wherein:
the receptacle includes a concave bottom surface, a cylindrical sidewall and a furrow between the concave bottom surface and the cylindrical sidewall, the furrow defining a perimeter of the receptacle; and
the step of inserting the rim of the receptacle into the gap causes the conduit to shift from an apex of the concave bottom surface to the furrow.

18. The method of claim 17, wherein a distal end of the tubular extension includes an exit port adapted, the method further comprising:
impeding the semi-solid food from flowing through the exit port; and
permitting the semi-solid food to flow through the exit port when subject to a negative pressure differential.

19. An autonomous feeding system, comprising:
a receptacle having a rim defining a receptacle opening, the receptacle adapted to contain a semi-solid food;
an adapter comprising:
a cover portion positionable over the receptacle opening, the cover portion having an undersurface and a top surface;
an outer sidewall defining a first perimeter on the undersurface;
an inner sidewall defining a second perimeter on the undersurface, the inner sidewall spaced apart from the outer sidewall to form a gap adapted to receive the rim of the receptacle;
a projection extending away from the undersurface at the opening, the projection defining a projection channel in fluid communication with the extension channel; and
a tubular extension extending away from the top surface of the cover portion, the tubular extension defining an extension channel and having a distal end defining an opening and a proximal end adjacent the cover portion; and
a conduit defining a conduit channel and positionable to extend away from the undersurface of the cover portion while in fluid communication with the extension channel of the tubular extension; and
wherein the inner sidewall, the outer sidewall and the rim of the receptacle are adapted to form a rim seal within the gap and the adapter includes an opening adapted to receive a first end of the conduit and projection extending away from the undersurface at the opening, the opening and the first end of the conduit forming a conduit seal at a conduit-extension interface.

20. The autonomous feeding system of claim 19, wherein:
the receptacle includes a concave bottom surface, a cylindrical sidewall and a furrow between the concave bottom surface and the cylindrical sidewall, the furrow defining a perimeter of the receptacle, the conduit adapted to extend between the furrow and the opening of the adapter; and
the distal end of the tubular extension includes an exit port adapted to impede the semi-solid food from flowing through the exit port when the receptacle opening is positioned downward while permitting the semi-solid food to flower through the exit port when subject to a negative pressure differential; and
the rim seal and the conduit seal substantially prevent the flow of the semi-solid food.
